(19) United States
(12) Patent Application Publication
(10) Pub. No.: US 2005/0222368 A1
(43) Pub. Date: Oct. 6, 2005

(54) Aqueous polyurethane dispersions

(76) Inventors: Juergen Reiners, Leverkusen (DE); Tillmann Hassel, Pulheim (DE); Gerald Kurek, Leverkusen (DE)

Correspondence Address: LANXESS CORPORATION, 111 RIDC PARK WEST DRIVE, PITTSBURGH, PA, 15275-1112, US

(21) Appl. No.: 11/093,158

(22) Filed: Mar. 29, 2005

(30) Foreign Application Priority Data
Mar. 30, 2004 (DE) 1020040154309

(51) Int. Cl. C08G 18/28

(52) U.S. Cl. 528/73

(57) ABSTRACT

Polyurethane which is obtainable by reacting a) an NCO-containing prepolymer composed of a1) at least one polyesterpolyol, preferably polycarbonatepolyol, carbonate group-free polyesterpolyol, polyestercarbonatepolyol, polyesteramidepolyol, in particular polyesterdiol, having an average molecular weight, determined as the number average, greater than or equal to 500 g/mol, preferably from 500 to 6000 g/mol, in particular from 500 to 4000 g/mol, very particularly preferably from 800 to 4000 g/mol, and a2) at least one polyetherpolyol which differs from a1) and is preferably polyalkylene glycol, such as polyethylene glycol, polypropylene glycol, polytetramethylene glycol, polyhexamethylene glycol and copolyethers, in particular those containing building blocks from the group consisting of ethyleneoxy, propyleneoxy, tetramethyleneoxy and/or hexamethyleneoxy, having a molecular weight, determined as the number average, greater than or equal to 500, preferably from 500 to 10 000 g/mol, in particular from 500 to 4000, particularly preferably from 800 to 4000, g/mol, preferably a polyetherdiol, and a3) at least one polyol, in particular diol, having a molecular weight of less than 500 g/mol, which carries one or more ionic groups and/or one or more potentially ionic groups, preferably carries one or more carboxylate groups, and a4) at least one aliphatic polyisocyanate, preferably diisocyanate, preferably having a molecular weight of less than 500 g/mol, in particular from 112 to 400 g/mol, particularly preferably from 168 to 262 g/mol, and a5) optionally a nonionic polyol, preferably diol having a molecular weight of less than 500 g/mol, preferably from 61 to 499 g/mol, and a6) optionally a monoalcohol with b) at least one polysiloxane reactive towards NCO groups and having a molecular weight, determined as the number average, of less than 1500 g/mol, preferably having 1 to 6, in particular 1 to 3, amino and/or hydroxyl groups reactive towards NCO groups, in particular amino groups, and c) at least one amine reactive towards NCO groups and having an average amino functionality of from 1 to 6 and a molecular weight of less than 500 g/mol (molecular weight determined as the number average), which may be substituted by hydroxyl groups and/or sulpho groups and/or carboxyl groups, and d) water, the molar ratio of the hydroxy-functional compounds used for the preparation of the prepolymer a) to the polyisocyanate being from 1: 1.1 to 1: 2.5, preferably from 1.1:1 to 1: 1.7.

The invention relates to polyurethane dispersions which contain polysiloxane building blocks reactive towards isocyanates, a process for their preparation and their use for coating leather.

Numerous polyurethane-based binders for aqueous coating, in particular for the finishing of leathers, are already known.

With the aid of a suitable finish, it is possible to produce leather articles in accordance with fashion trends. Apart from the aesthetic aspects, the finish has a protective function and serves for maintaining the value of leather and improving the suitability for use. Finishing is understood as meaning the application of binders, dyes, pigments, waxes, hand compositions and further auxiliaries by means of the customary application techniques, such as spraying, printing, casting, application of the doctor blade or application with a plush pad, to the tanned hide. This application can be effected in one coat but is as a rule carried out in a plurality of coats, further process steps, such as intermediate drying, plating, embossing and milling, being customary in practice. After each application of a finish coat, the leathers should usually be stackable. This is possible only if the freshly applied finish coat is nontacky after drying. The technical possibilities for drying an aqueous finish coat on leather are limited; it is possible to reach only 90° C. to—briefly—100° C. because otherwise the shrinkage temperature of the leather is exceeded. The drying time in a drying tunnel is as short as possible for productivity reasons, and the drying temperature is low owing to the shrinkage temperature of the leather.

Owing to these limitations, polymer dispersions which, after drying on, give a nontacky finish film capable of withstanding a mechanical load are used in the aqueous finishing of leather.

The total leather finish consists as a rule of a multicoat structure which imposes as small a load as possible on the grain, for example the following coats being applied to the leather: prebottoming, bottoming, optionally pigmented intermediate coat and top coat. If required, the desired grain pattern for a certain leather article is applied by embossing after the bottoming. The bottoming, as an intermediate coat under the top coat, should ensure good adhesion between substrate and top coat and serves for preparing the surface for the final coat. In addition to this good adhesion, good flexing endurance and hydrolysis stability of the finish and embossability of the bottomed substrates are of decisive importance. Binders whose films are very soft but nevertheless must not be tacky are therefore required as bottoming binders. Particularly when embossing under pressure/heat, the coated leathers must not adhere to the embossing plate, which would disturb the work sequence or, in an extreme case, even destroy the finish coat. On the other hand, the grain pattern applied by embossing should be as an exact as possible image of the pattern on the embossing plate and should relate as exactly as possible to the natural grain pattern. A round grain is as a rule desired because it corresponds most closely to the natural appearance of a full grain leather. The embossing should not therefore be too sharp or too angular and should not cut through the binder coat. In this case, the finish would very easily break open later on under mechanical stress. An important property of bottoming binders are also good levelling properties of the aqueous dispersions on the crust leather and the formation of a cohesive and nontacky film during the drying process. Once the embossed pattern has been produced, it should not suffer in spite of the thermal load to which the leather is exposed during the further processing (drying of the top coat, plating or milling). The embossing should not lose its crisp contours, for example as a result of the application of a top coat and during plating or during milling.

However, known aqueous bottoming coats have substantial disadvantages: for example, the levelness is often not optimum and the formation of a cohesive film is complicated. In industrial finishing, an attempt is made to compensate for these disadvantages by adding levelling agents. Good levelling and optimum film formation of the binders of a finish system are essential for achieving the required aspect and fastness level of the finish. This also applies in particular to the uppermost finish coat, the so-called top coat. A decisive disadvantage in the case of some bottoming coats is also the poor hydrolysis stability or insufficient adhesion of intermediate coats.

In general, polymer dispersions are used for bottoming. Here, polyurethane dispersions give bottoming coats having particularly good fastnesses, in particular hydrolysis stability, rub fastness and dry, wet and low-temperature flexing endurances. The polyurethane dispersions used to date give films which are either very soft and therefore too tacky or are too hard, which adversely affects the adhesion of intermediate coats. The embossability, i.e. the behaviour during the actual embossing process, and the embossing behaviour, i.e. the accuracy of reproduction and the behaviour of the embossing during the further processing, are still in need of improvement.

The adhesion to the embossing plate during the actual embossing process can be reduced, for example, by mixing abhesive additives, such as silicone oils of the polydimethylsiloxane type, into the spray batch with the bottoming binder and applying these together to the leather. A disadvantage thereby is that only very small amounts of silicone are permitted to be present since otherwise very pronounced levelling defects occur. In addition, the silicones may migrate out of the finish and cause an undesired fatty hand, cause fogging problems or be troublesome simply by virtue of the fact that they contaminate other surfaces and cause further damage there.

Since silicones are known to have very strongly abhesive or water repellent properties, the subsequence application of a top coat, for example of an aqueous polyurethane dispersion, is hindered or even made impossible by levelling defects. Moreover, even on successful application of the top coat and subsequent drying, the intermediate adhesion may, in spite of the crosslinking agent used, be so poor that the top coat film may be pulled off extensively from the bottoming coat in the peel test. For the end user, such leathers are completely unusable.

Polyurethane dispersions having good embossability possess, as a rule, relatively soft films. Bottoming binders possess, as a rule, a Shore A hardness of less than 60. Even softer bottoming binders having a Shore A hardness of from 30 to 50 are desirable, but the coated leathers tend to stick and cannot be stacked one on top of the other during processing. In such cases, the tack can be reduced, for example, by using waxes or silicone oils in the finish formulation, but this may give rise to other problems: thus, the risk of poor adhesion of the top coat to the bottoming coat is very high. In addition, the fogging is a serious problem for automotive leather. Low molecular weight additives should therefore be minimized.

In the aqueous finishing of leather, polyurethane dispersions are not used together with polydimethylsiloxane additives as detackifiers, or used together with said additives only in exceptional cases, because, after drying on, such products may lead to levelling defects (fish eyes, crater formation, island formation), which prevents industrial use or requires further levelling auxiliaries in order to be able to compensate some of these disadvantages.

Silicone-modified polyurethane dispersions in which a polysiloxane building block is incorporated into the polyurethane chain are already known.

WO 00/0064971 (=EP-A-1192214) discloses siloxane-containing polyurethane/urea elastomer compositions in which amine chain extenders, such as 1,3-bis(3-aminopropyl)tetramethyldisiloxane, are used. No polyurethane dispersions are described.

WO 99/058100 (=EP-A-1077669) describes film-forming polymers based on silicone-modified polyurethanes for use in hair setting compositions. A polysiloxanediamine (Tegomer® A-Si 2122) is used as a chain extender. This is a multicomponent system which can be readily washed out of the hair. Such products are not suitable for the finishing of leather.

EP-A-938889 claims a similar inventive subject. Here too, a polyurethane dispersion which can be used as a hair setting composition and can be removed by washing out is involved.

EP-A-841358 describes siloxane-modified polyurethanes which are suitable for the production of patterned leathers. These are solvent-containing systems which contain polyurethanes which are obtained by reacting polyisocyanates with hydroxyl-terminated poly(dimethylsiloxanes).

EP-A-1354902 describes aqueous polysiloxane/polyurethane dispersions and their use in coating materials, in particular for use as soft feel finishes. Certain polydimethylsiloxanediols having a molecular weight range of from 1500 to 10 000 g/mol are incorporated in an amount of from 3 to 25%, based on polyurethane solid. Tegomer® H-Si 2111, Tegomer® H-Si 2311 or Tegomer® H-Si 6440 from Goldschmidt AG are preferred as suitable polysiloxanediols.

WO-A-03/091349 describes aqueous coating compositions for the production of seals, consisting of at least one crosslinkable polyurethane-based binder, optionally a crosslinking agent, and spherical particles of polysilsesquioxanes.

WO-A-01/16200 describes cosmetic compositions, in particular hair treatment compositions, based on oligomers and polymers containing urethane and/or urea groups, which contain, as a building block, polysiloxanes having at least two active hydrogen atoms per molecule. However, the preparation involves a separate preparation of a hydroxy-functional oligomer which contains the polysiloxane building block. For example, an excess of a polysiloxanediol (Tegomer® H-Si 2122) is reacted with a diisocyanate and this mixture is reacted with other polyols to give polyurethanes which may also be water-dispersible. These products are not suitable for leather finishing, owing to the complex requirements. Thus, the mechanical properties and the hydrolysis, which are required in leather finishing, are not achieved.

WO-A-02/12364 describes polyurethane (polymer hybrid) dispersions having reduced hydrophilicity and their use in binders, inter alia for the production of floor coverings. The polyurethane dispersions contain a hydrophobically modified block copolymer which consists of hydrophobic segments, such as, for example, polybutylene oxide, polydodecyl oxide, etc., and polypropylene oxide segments. In the list of hydrophobic segments, α,ω-polymethacrylatediols (Tegodiol) and α,ω-dihydroxyalkylpolydimethylsiloxanes are also mentioned.

Improved polyurethane dispersions which meet the abovementioned requirements are therefore still being sought. It was an object of the present invention to overcome the stated disadvantages of the known products. In particular, the polyurethane dispersions should have as high a strength as possible in combination with low hardness and should dry on to give soft, strongly adhering but nevertheless nontacky films.

Surprisingly, the polyurethane described below has now been found.

The invention relates to a polyurethane which is obtainable by reacting
a) an NCO-containing prepolymer composed of
   a1) at least one polyesterpolyol, preferably polycarbonatepolyol, carbonate group-free polyesterpolyol, polyestercarbonatepolyol, polyesteramidepolyol, in particular polyesterdiol, having an average molecular weight, determined as the number average; greater than or equal to 500 g/mol, preferably from 500 to 6000 g/mol, in particular from 500 to 4000 g/mol, very particularly preferably from 800 to 4000 g/mol, and
   a2) at least one polyetherpolyol which differs from a1) and is preferably free of ester groups, preferably polyalkylene glycol, such as polyethylene glycol, polypropylene glycol, polytetramethylene glycol, polyhexamethylene glycol and copolyethers, in particular those containing building blocks from the group consisting of ethyleneoxy, propyleneoxy, tetramethyleneoxy and/or hexamethyleneoxy, having a molecular weight, determined as the number average, greater than or equal to 500, preferably from 500 to 10 000 g/mol, in particular from 500 to 4000, particularly preferably from 800 to 4000, g/mol, preferably a polyetherdiol, and
   a3) at least one polyol, in particular diol, having a molecular weight of less than 500 g/mol, which carries one or more ionic groups and/or one or more potentially ionic groups, preferably carries one or more carboxylate groups, and
   a4) at least one aliphatic polyisocyanate, preferably diisocyanate, preferably having a molecular weight of less than 500 g/mol, in particular from 112 to 400 g/mol, particularly preferably from 168 to 262 g/mol, and
   a5) optionally a nonionic polyol, preferably diol having a molecular weight of less than 500 g/mol, preferably from 61 to 499 g/mol, and
   a6) optionally a monoalcohol
      with
b) at least one polysiloxane reactive towards NCO groups and having a molecular weight, determined as the number average, of less than 1500 g/mol, preferably having 1 to 6, in particular 1 to 3, amino and/or hydroxyl groups reactive towards NCO groups, in particular amino groups, and
c) at least one amine reactive towards NCO groups and having an average amino functionality of from 1 to 6 and a molecular weight of less than 500 g/mol (molecular weight determined as the number average), which may be substituted by hydroxyl groups and/or sulpho groups and/or carboxyl groups, and
d) water,
   the molar ratio of the hydroxy-functional compounds used for the preparation of the prepolymer a) to the polyisocyanate being from 1:1.1 to 1:2.5, preferably from 1.1:1 to 1:1.7.

The polyurethane according to the invention preferably has an average molecular weight, determined as the number average, of from 5000 to 50 000, preferably from 7000 to 40 000, particularly preferably from 8000 to 30 000, g/mol.

The invention furthermore relates to a polyurethane dispersion, preferably aqueous polyurethane dispersion, containing in particular from 10 to 60% by weight of the polyurethane according to the invention, particularly preferably from 25 to 50% by weight, based on the dispersion.

Prepolymer a)

In general, the polyols a1) and a2) have no ionic groups or potential ionic groups, apart from terminal carboxyl groups in polyesterpolyols, which, proportionately, cannot always be avoided during the preparation thereof.

The following may be used as a suitable polyesterpolyol of component a1): carbonate group-free polyesters, polycarbonates, polyestercarbonates and polyesteramidepolyols of the molecular weight range from 500 to 6000 g/mol.

For example, the following may be mentioned as such: reaction products of polyhydric, preferably dihydric, alcohols with preferably dibasic carboxylic acids. Instead of the polycarboxylic acids, it is also possible to use the corresponding polycarboxylic anhydrides or corresponding polycarboxylic esters of lower alcohols or mixtures thereof for the preparation of the polyesters. The polycarboxylic acids may be aliphatic, cycloaliphatic, aromatic and/or heterocyclic and may be optionally substituted, for example by halogen atoms, and/or unsaturated. The following may be mentioned as examples of these: succinic acid, succinic anhydride, adipic acid, glutaric acid, suberic acid, azelaic acid, sebacic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, oleic acid, dimethyl terephthalate and bisglycol terephthalate.

Examples of polyhydric alcohols which are suitable for the preparation of the polyesters are ethylene glycol, 1,2- and 1,3-propylene glycol, 1,4-, 1,3- and 2,3-butylene glycol, 1,6-hexanediol, 1,8-octanediol, the diol obtained by reduction of dimer fatty acid, neopentylglycol, cyclohexanedimethanol, 2-methyl-1,3-propanediol, and furthermore diethylene glycol, triethylene glycol, tetraethylene glycol, polyethylene glycol, dipropylene glycol, polypropylene glycol, dibutylene glycol and polybutylene glycol. The polyesters may have terminal carboxyl groups in proportionate amounts. Polyesters obtained from lactones, in particular caprolactone, can also be used.

The particularly preferred polyesterpolyols, in particular polyesterdiols, are dicarboxylic acid polyesterpolyols, the dicarboxylic acid component of which comprises at least 50 carboxyl equivalent % of adipic acid, particularly preferably exclusively adipic acid, and the polyol component of which preferably comprises at least 50 hydroxyl equivalent % of 1,4-dihydroxybutane, 1,6-dihydroxyhexane or neopentylglycol.

Polycarbonates having hydroxyl groups are also suitable as component a1) or as a constituent of component a1), for example those which can be prepared by reacting diols, such as 1,3-propanediol, 1,4-butanediol and/or 1,6-hexanediol, the diol obtained by reduction of dimer fatty acid, neopentylglycol, diethylene glycol, triethylene glycol or tetraethylene glycol, with dicarbonates, e.g. diphenyl carbonate, dimethyl carbonate, diethyl carbonate or phosgene. The polycarbonates may proportionately also contain ester groups, which may form by incorporation of lactones, in particular caprolactonediol, during the condensation. Any desired mixtures of the polyhydroxy compounds mentioned by way of example can also be used as component a1).

The following may be particularly preferably mentioned:

Dihydroxypolyesters obtained from dicarboxylic acids or the anhydrides thereof, e.g. adipic acid, succinic acid, phthalic anhydride, isophthalic acid, terephthalic acid, suberic acid, azelaic acid, sebacic acid, tetrahydrophthalic acid, maleic anhydride, dimer fatty acids and diols, e.g. ethylene glycol, propylene glycol, 1,4-propanediol, diethylene glycol, triethylene glycol, 1,4-butanediol, 1,6-hexanediol, trimethylenepentanediol, 1,4-cyclohexanediol, 1,4-cyclohexanedimethanol, neopentylglycol, 1,8-octanediol or dimerdiol; polyesters and lactone-based, in particular ε-caprolactone-based, polycarbonates, and polycarbonates as are obtainable by reacting, for example, the abovementioned diols with diaryl or dialkyl carbonates or phosgene.

Suitable components a2) are polyetherpolyols, as can be obtained, by polymerization of ethylene oxide and/or propylene oxide, for example using low molecular weight polyols, preferably diols, or water as an initiator molecule. Suitable initiator alcohols are usually ethylene glycol, 1,2-propanediol, 1,3-propanediol, 1,4-butanediol, 1,6-hexanediol, glycerol, glucose, sorbitol, trimethylolpropane and pentaerythritol, and corresponding oligoethers which form as a result of an addition reaction of ethylene oxide and/or propylene oxide with these polyols. Polyethers which have particularly narrow molecular weight distributions and no terminal groups formed by secondary reactions are also particularly preferred, such as, for example, the strictly bifunctional propylene oxide-polyethers, which are obtainable by means of so-called DMC (double metal cyanide) catalysts.

The polyethers obtained by polymerization of tetrahydrofuran and copolyethers which are composed of monomers from the group consisting of tetrahydrofuran, ethylene oxide and/or propylene oxide with random or block-like sequences in the polymer chain are also suitable.

Particularly suitable polyols of component a1) are polycarbonatediols and polyestercarbonatediols, and those of component a2) are polytetrahydrofurandiols.

Among these particularly suitable polyols, hexanediol-polycarbonatediols and/or caprolactone-hexanediol-polycarbonatediols are preferred as component a1) and polytetrahydrofurandiols as component a2), in particular those of the molecular weight range from 1000 to 3000 g/mol.

In particular, carboxylic acid or carboxylate group-carrying diols are suitable as the diol of component a3) which carries ionic or potentially ionic groups, such as, for example, 2,2-bis(hydroxymethyl)alkanecarboxylic acids, such as dimethylolacetic acid, 2,2-dimethylolpropionic acid, 2,2-dimethylolbutyric acid, 2,2-dimethylolpentanoic acid and dihydroxysuccinic acid.

Dimethylolpropionic acid is preferably used.

Suitable aliphatic isocyanates of component a4) are, for example, isocyanates, such as, for example, hexamethylene diisocyanate, butylene diisocyanate, isophorone diisocyanate, 1-methyl-2,4(2,6)-diisocyanatocyclohexane, norbornylene diisocyanate, xylylene diisocyanate, tetramethylxylylene diisocyanate, hexahydroxyxylylene diisocyanate and 4,4′-diisocyanatodicyclohexylmethane.

4,4′-Diisocyanatodicyclohexylmethane and/or isophorone diisocyanate and/or hexamethylene diisocyanate and/or 1-methyl-2,4(2,6)-diisocyanatocyclohexane are preferably used. In addition, higher functional polyisocyanates, so-called coating polyisocyanates, such as dimers or trimers of hexamethylene diisocyanate or isophorone diisocyanate, 1,3-bis(6-isocyanatohexyl)-5-oxa-1,3-diazine-2,4,6-trione, and isocyanates containing carbodiimide groups, allophanate groups or biuret groups and capable of being prepared on the basis of hexamethylene diisocyanate are also suitable.

The following are suitable as preferred polyols, in particular Si-free polyols, preferably diols of component a5): ethylene glycol, 1,4-butanediol, 1,6-hexanediol, neopentylglycol, trimethylpentanediol, trimethylolpropane, pentaerythritol, 1,2-propanediol, 1,3-propanediol, 1,4-cyclo-hexanedimethanol, 2,4-diethyl-1,5-pentanediol, 2-butyl-2-ethyl-1,3-propanediol, 2-ethyl-1,3-hexanediol, 1,4-bis(2-hydroxyethoxy)benzene, bis-hydroxymethyl-tricyclo[5.2.1.0^{2,6}]decane, bis(2-hydroxyethoxymethyl)-tricyclo[5.2.1.0^{2,6}]decane and mixtures thereof. 1,6-Hexanediol, 1,3-propanediol or 1,4-butanediol are preferably used.

For example, monofunctional alcohols of the aliphatic and araliphatic series or corresponding polyetheralcohols may be used as optionally present component a6). The use of aliphatic alcohols is preferred, in particular C₁-C₁₀-alcohols.

For example, the following can be used: methanol, ethanol, propanol, butanol, hexanol, 2-ethylhexanol, 2-methoxyethanol, diethylene glycol monomethyl ether and benzyl alcohol, polyoxyethylene monoalkyl ether, polyoxypropylene monoalkyl ether and monoalkyl-terminated copolyethers obtained from ethylene oxide and propylene oxide. Herein, the term “monoalkyl-” preferably represents C₁-to C₄-alkyl radicals, such as methyl, ethyl, propyl or butyl. 2-Ethylhexanol and monofunctional polyethers based on ethylene oxide and/or propylene oxide and having a molecular weight of not more than 2500 g/mol are particularly preferred.

In a preferred embodiment, the molar ratio of the components a6) acting as chain terminators is chosen so that the desired NCO functionality of the polyurethane prepolymer is established. In particular, it is advantageous to use the components a6) if components having a functionality greater than 2 are used as building blocks for the preparation of the polyurethane.

The molar ratio of the components a1) to a6), based on 1000 g of prepolymer a), is
from 0.1 to 1.70, preferably from 0.5 to 1.20, mole equivalents of OH of component a1),
from 0.1 to 1.70, preferably from 0.5 to 1.20, mole equivalents of OH of component a2),
from 0.1 to 1.0, preferably from 0.2 to 0.7, mole equivalent of OH of component a3),
from 1.0 to 3.5, preferably from 0.7 to 3.0, mole equivalents of NCO of component a4) and
from 0 to 1.0, preferably from 0 to 0.5, mole equivalent of OH of component a5) and
from 0 to 0.2, preferably from 0.001 to 0.2, mole equivalent of OH of component a6),
   the molar ratio of the sum of all mole equivalents of NCO from the component a4) and the sum of all mole equivalents of OH from the components a1), a2), a3), a5) and a6) being from 1.05 to 2.5: 1, preferably from 1.1 to 1.7: 1; a ratio of from 1.20 to 1.60: 1 is very particularly preferred.

Very particularly preferred polyurethanes according to the invention are those in which the ratio of the mole equivalents of OH from component a1) to component a2) is from 1:3 to 4:1 and the content of ionic groups from component a3) is from 50 to 700 milliequivalents of carboxylate or sulphonate groups, preferably from 100 to 300 milliequivalents of carboxylate groups, based on 1000 g of polyurethane.

The molar sum of the components a6), based on 1000 g of prepolymer a), is preferably from 0 to 0.2 mol, preferably from 0.001 to 0.2 mol, particularly preferably from 0.01 to 0.1 mol, of OH.

Suitable polysiloxane components b) are NCO-reactive polydimethyl-siloxanes which have primary amino groups, secondary amino groups or hydroxyl groups or mixtures thereof. In addition, the polysiloxane components may also contain further functional groups which are not NCO-reactive, for example acyl groups, such as formyloxy, formamido, acetoxy, propionyloxy, butanoyloxy or tertiary amino groups, sulphonate groups, phosphonate groups or polyether units which are derived from ethylene oxide and/or propylene oxide units.

Linear polysiloxanes which have at least one primary amino group, secondary amino group or hydroxyl group are preferred, the functions preferably being arranged as terminal groups and/or side groups in the polysiloxane chain and being linked to the siloxane chain via an organic radical as a bridge member. Suitable bridge members are divalent organic radicals, such as methylene, ethylene or propylene radicals or divalent hydrocarbon radicals interrupted by oxygen or tertiary amino groups, such as the ethylene-3-oxypropyl, propylene-3-oxypropyl or ethylene-3-(N-methyl)aminopropyl radical.

Linear terminally substituted polydimethylsiloxanes which have aminomethyl, aminopropyl, hydroxypropyl, hydroxymethyl or hydroxyethoxy(alkyleneoxy)-propyl groups as NCO-reactive groups are particularly preferred. Polysiloxanes which are obtained by reacting polysiloxanes containing terminal epoxy groups with amines, diamines or hydroxyalkylamines are furthermore suitable. Polysiloxanes which are obtainable by reacting aminopropyl- or aminoethylaminopropyl-terminated polysiloxanes with alkylene oxides are also suitable. Polysiloxanes which have an average molar mass of less than 1500 g/mol, preferably greater than 400 and less than 1500 g/mol, are particularly preferred.

Terminally-substituted polysiloxanes having secondary and/or primary amino groups or hydroxyl groups, in particular amino groups, which have a content of unfunctionalized polysiloxanes, in particular permethylated cyclic siloxanes of less than 5%, preferably less than 1%, particularly preferably a content of D3 (hexamethylcyclotrisiloxane), D4 (octamethylcyclotetrasiloxane) and D5 (decamethylcyclopentasiloxane) of in each case less than 0.1% and have an average molar mass of from 400 to 1490 g/mol, are very particularly preferred.

Polysiloxanes which have a functionality of groups reactive toward isocyanates of from 1 to 3, particularly preferably from 1.8 to 2.2, very particularly preferably from 1.95 to 2.05, are also preferred.

The amines of component c) preferably serve for chain extension of the NCO prepolymer according to the preparation processes, explained further below, for the polyurethanes according to the invention. Suitable compounds of component c) are, for example, ethylenediamine, diethylenetriamine, hexamethylenediamine, isophoronediamine, dicyclohexylmethane-diamine, ethanolamine, propanolamine, N-methylethanolamine, diethanolamine, N,N,N′-tris-2-hydroxyethylethylenediamine, 2-aminoethyl-2-aminoethanesulphonic acid sodium salt or potassium salt, 2-aminoethyl-2-aminoethanecarboxylic acid sodium salt or potassium salt, the adduct of isophoronediamine and acrylic acid in the molar ratio 1:1 (as sodium or potassium salt). Ethylenediamine and diethylenetriamine are preferably used.

The component c) serves in particular for further increasing the molar mass of the polyurethane. NH₂ groups form thereby by reaction with the NCO groups and react with further NCO groups with an increase in the molar mass by urea linkage. If free isocyanate groups still remain after the reaction of the NCO prepolymer, they are completely converted into urea groups with chain extension during the dispersing in water.

In the context of this Application, polyurethanes are therefore also understood as meaning polyurethaneureas.

It is also preferable to establish the molar absolute amount of the components a) to d) so that the resulting number average molar mass of the polyurethane according to the invention is from 5000 to 50 000 g/mol, preferably from 7000 to 40 000 g/mol, in particular from 8000 to 30 000 g/mol.

It is preferable to establish the absolute amount of polysiloxane component b) so that a film applied from the polyurethane dispersion to a glass plate and dried is clear and transparent. The polysiloxane component b) is preferably used in absolute amounts of from 0.0001 to 10% by weight, preferably from 0.001 to 2.5% by weight, particularly preferably from 0.001 to 1% by weight, based in each case on the polyurethane according to the invention.

Polyurethanes according to the invention in which the molar ratio of the polysiloxane component b) to the NCO groups of the prepolymer a) is from 0.0001 to 0.2, preferably from 0.01 to 0.1, particularly preferably from 0.01 to 0.05, are preferred.

Polyurethanes according to the invention in which the molar ratio of amine chain extender (component c)) to the NCO groups of the prepolymer a) is from 0.1 to 0.98, preferably from 0.20 to 0.95, particularly preferably from 0.25 to 0.80, are preferred.

It is also preferable if the content of ionic groups, in particular of carboxylate groups, of the polyurethane is from 50 to 2000, preferably from 50 to 1000, in particular from 100 to 500, milliequivalents, based on 1000 g of the polyurethane.

Preferred polyurethanes are composed of:
0.2-0.6 mole equivalent of OH, particularly preferably 0.2-0.5 mole equivalent of OH, of component a1),
0.5-1.2 mole equivalents of OH, particularly preferably 0.7-1.1 mole equivalents of OH, of component a2),
0.1-0.7 mole equivalent of OH, particularly preferably 0.2-0.5 mole equivalent of OH, of component a3),
1.0-3.0 mole equivalents of NCO, particularly preferably 1.5-2.5 mole equivalents of NCO, of component a4),
0-0.5 mole equivalent of OH, particularly preferably 0-0.3 mole equivalent of OH, of component a5),
0.001-0.20 mole equivalent of OH, particularly preferably 0.01-0.10 mole equivalent of OH, of component a6),
0.001-0.1 mole equivalent of NH, particularly preferably 0.001-0.07 mole equivalent of NH, of component b),
0.2-0.95 mole equivalent of NH, particularly preferably 0.25-0.8 mole equivalent of NH, of component c) and
0.005-0.1 mole equivalent of water (component d),
   the ratio of the sum of all moles of NCO from the component a4) to the sum of all mole equivalents of OH from the components a1), a2), a3), a5) and a6) being from 1.05 to 2.5: 1, preferably from 1.1 to 1.7: 1, particularly preferably from 1.20 to 1.60: 1, and the content of ionic groups from component a3) being from 50 to 700 milliequivalents of carboxylate groups, based on polyurethane, preferably from 100 to 300 milliequivalents of carboxylate groups, based on polyurethane, a tertiary amine or alkanolamine being used for the neutralization of the carboxyl groups and the degree of neutralization being from 50 to 100%.

Very particularly preferred polyurethanes according to the invention are those which are composed of
0.2-0.6 mole equivalent of OH, particularly preferably 0.2-0.5 mole equivalent of OH, of a polyestercarbonatediol of component a1), preferably of a polyestercarbonatediol having a molar mass of from 800 to 4000 g/mol which is obtainable from hexanediol, caprolactone and dialkyl carbonates/diol carbonates with polycondensation, in particular with melt polycondensation in vacuo by removal of the alcohol from the reaction mixture,
0.5-1.2 mole equivalents of OH, particularly preferably 0.7-1.1 mole equivalents of OH, of an ester group-free polyetherdiol of component a2), preferably a polytetrahydrofurandiol having a molar mass of from 750 to 4000 g/mol,
0.1-0.7 mole equivalent of OH, particularly preferably 0.2-0.5 mole equivalent of OH, of the dimethylolpropionic acid of component a3),
1.0-3.0 mole equivalents of NCO, particularly preferably 1.5-2.5 mole equivalents of NCO, of diisocyanates of component a4), preferably from the group consisting of hexamethylene diisocyanate, isophorone diisocyanate and dicyclohexylmethane diisocyanate, particularly preferably hexamethylene diisocyanate as a mixture with isophorone diisocyanate and/or dicyclohexylmethane diisocyanate, in particular having a molar hexamethylene diisocyanate:isophorone diisocyanate:dicyclohexylmethane diisocyanate ratio of 3:1:0.1 to 1:3:3,
0-0.5 mole equivalent of OH, particularly preferably 0-0.3 mole equivalent of OH, of a diol of component a5), preferably from the group consisting of propanediol, butanediol or hexanediol,
0.001-0.20 mole equivalent of OH, particularly preferably 0.01-0.10 mole equivalent of OH, of a monoalcohol of component a6), preferably ethylhexanol,
0.001-0.1 mole equivalent of NH, particularly preferably 0.001-0.07 mole equivalent of NH, of an α,ω-bis(3-aminopropyl)-polydimethylsiloxane of component b), having a molar mass of 700-1000 g/mol-and an amine functionality of 1.95-2.05,
0.2-0.95 mole equivalent of NH, particularly preferably 0.25-0.8 mole equivalent of NH, of a component c) from the group consisting of ethylenediamine, isophoronediamine, diethylenetriamine and hexamethylenediamine, in particular of a mixture of ethylenediamine and diethylenetriamine in the NH molar ratio of 0.1:1 to 1:0.1, and
0.005-0.1 mole equivalent of water of component d),
   the ratio of the sum of all mole equivalents of NCO from component a4) to the sum of all mole equivalents of OH from the components a1), a2), a3), a5) and a6) being from 1.05 to 2.5: 1, preferably from 1.1 to 1.7: 1, particularly preferably from 1.20 to 1.60: 1, and the content of ionic groups from components a3) being from 50 to 700, preferably from 100 to 300, milliequivalents of carboxylate groups, based on polyurethane, the carboxylate groups preferably being from 50 to 100% neutralized with a tertiary amine or alkanolamine.

The polyurethane dispersions according to the invention preferably contain less than 1% by weight, preferably less than 0.1% by weight, of an organic solvent.

In a particularly embodiment, the mean particle size of the polyurethane is less than 200 nm, preferably from 20 to 150, in particular from 40 to 100 nm.

The particle size is preferably determined by means of laser correlation spectroscopy, sedimentation in the ultracentrifuge or electron microscopy.

The invention furthermore relates to a process for the preparation of the polyurethanes according to the invention, which is characterized in that the components a1) to a4) and optionally a5) and/or a6) are reacted to give an NCO prepolymer, and this is reacted with the components b) and c) and water to give a polyurethane. The polysiloxane component b) is preferably completely incorporated thereby.

The molar sum of all components b), based on 1000 g of prepolymer, is preferably at least 0.0001 mol, preferably from 0.001 to 0.6 mol, particularly preferably from 0.002 to 0.5 mol.

In a preferred embodiment, the process is characterized in that either an NCO prepolymer is synthesized from the components a1) to a4) and optionally a5) and/or a6) and the NCO prepolymer is then reacted with the component b) and the optionally present potential ionic groups, in particular carboxylic acid groups, are then neutralized with a base which is not reactive towards NCO groups, and the neutralized prepolymer is reacted with water and the component c) or an NCO prepolymer is prepared by reacting a mixture containing the components a1) to a4) and optionally a5) and/or a6), the optionally present potentially ionic groups, in particular carboxylic acid groups, are then neutralized by adding a base which is not reactive towards NCO groups and reacted with component b) and dispersed in water, and the neutralized prepolymer is reacted with the component c).

The process according to the invention is preferably carried out by the melt dispersing method. The melt dispersing method is characterized in that an NCO prepolymer—either as a melt or as a solution in a non-NCO-reactive, water-miscible solvent—containing an amount of incorporated ionic groups which is sufficient for the formation of a stable dispersion—or potentially ionic groups converted into ionic groups by prior neutralization is either stirred into water or water is stirred into the prepolymer. In order to facilitate the dispersing, it is also possible to add water-dispersible polyisocyanates or classical external emulsifiers. Nonionic and anionic emulsifiers are particularly preferred. It is particularly preferable to add no further emulsifiers.

In general, a stable dispersion of the prepolymer forms. The NCO groups can then react by reaction with water; however, it is also possible to react them with preferably water-miscible amines.

Organic solvents which are not NCO-reactive and are miscible with water are preferably used in the prepolymer preparation in the process according to the invention.

The following may be mentioned as examples of suitable solvents for the preparation of the prepolymers a):

Ketones, such as acetone and butanone; ethers, such as tetrahydrofuran, dioxane and dimethoxyethane, ether-esters, such as methoxypropyl acetate (cyclic) amides and ureas, such as dimethylformamide, dimethylacetamide, N,N′-dimethyl-2,5-diazapentanone and N-methylpyrrolidone. Acetone is particularly preferred.

These solvents can be added in any stage of the prepolymer preparation.

However, a procedure in which the solvent is added only in the course of the reaction is particularly advantageous. In the initial phase of the prepolymer preparation, it is advantageous to carry out the reaction without addition of solvent.

The prepolymer preparation is preferably effected at temperatures of from 40 to 120° C., particularly preferably from 50 to 110° C.

The polysiloxane component b) is preferably reacted with the NCO prepolymer before the NCO prepolymer-is dispersed in water. In the case of amino-functional polysiloxanes, a reaction time of from 5 minutes to 2 hours at from 20° C. to 70° C. is preferred. The reaction is preferably effected before the neutralization with the base in the organic solution of the prepolymer.

In the case of the polysiloxanes b) having hydroxyl groups, earlier addition to the prepolymer a) is preferred in order to ensure as quantitative a reaction as possible of the polysiloxanes.

Polysiloxanes which have more than two hydroxyl groups and/or amino groups constitute a special case. Such polyfunctional compounds are preferably dissolved in acetone or added to the prepared dispersion of the prepolymer in water in order to avoid premature crosslinking.

Optionally present potentially ionic groups, in particular the carboxylic acid groups of the NCO prepolymer, are also preferably at least partly neutralized before the NCO polymer is dispersed in water. The degree of neutralization may be between 20% and 100%, based on carboxyl groups. A degree of neutralization of from 50 to 98% is particularly preferred. The neutralization is carried out at from 50 to 90° C.

Preferred bases for the neutralization of the carboxyl groups/sulphonate groups are ammonia or amines, in particular tertiary amines, such as trimethylamine, triethylamine, morpholine, N-methylmorpholine, N-methylpiperidine, dimethylethanolamine, methyldiethanolamine or N,N-dimethyl-N-[2-ethoxy]-ethylamine, tri-n-propylamine, dimethyl-2-propanolamine, triisopropylamine, diethylpropylamine, diethyl-2-hydroxypropylamine, 2-amino-2-methyl-1 propanol, diethyl-2-propanolamine, diethylaminopropylamine, triisopropanolamine or mixtures of these and other neutralizing agents, etc. Also suitable, but not preferred, are bases such as sodium hydroxide, potassium hydroxide, sodium carbonate, potassium carbonate and lithium hydroxide, in particular for the neutralization of sulphonate groups.

The component c) is preferably used in the presence of a 10- to 60-fold excess, based on weight, of water. This is preferably ensured by stirring the component c) together with the excess of water into the NCO prepolymer or by first dispersing the NCO prepolymer in water, preferably at a temperature of from 30 to 60° C., and, after the dispersing, immediately adding the component c), optionally as an aqueous solution.

This process variant is preferably carried out in such a way that first water is initially introduced and the reaction product of prepolymer a) and component b) is neutralized with a base and then added to the aqueous phase. A process variant in which the prepolymer solution is initially introduced and the water is metered into this solution is furthermore preferred. During the dispersing itself, a small part of the NCO groups reacts (component d). The component c) is therefore added immediately after the dispersing. After the addition of the component c), stirring is preferably continued until the reaction product has reacted with the stoichiometric amount of water (component d) and is NCO-free.

It is also possible to react the prepolymer a) in solution with component b) and—optionally a part of—component c), then to effect neutralization with the base, to disperse in water and then to add the remainder of the component c). Stirring is then continued until the product is NCO-free.

In all process variants, the solvent is preferably removed by distillation at the end of the reaction. Aqueous dispersions which have a solids content of from 20 to 60% by weight and a content of organic solvents of ≦<0.1% by weight are then obtained.

It is preferable if further additives are added to the polyurethanes according to the invention or their aqueous dispersions during their use for coating. For example, polyurethane-based or acrylate-based latices are suitable as further binders.

Other further additives may be viscosity regulators, organic bases for pH adjustment, antifoams, levelling auxiliaries, antioxidants, UV absorbers/light stabilizers and microbicides for stabilization. Such additives are generally used in a minor amount; the amounts are preferably from 100 ppm to 5%, based on the dispersion. Furthermore, the mixtures may contain dulling agents and further auxiliaries which are required for establishing certain hand properties.

The invention furthermore relates to a preferably aqueous polyurethane system containing the component A) and at least one of the components A1) and B):
A) at least one polyurethane according to the invention, preferably as an aqueous polyurethane dispersion,
A1) optionally one or more further polymer dispersions, such as polyacrylate dispersions or polyurethane dispersions, and
B) optionally a water-dispersible, aliphatic or cycloaliphatic polyisocyanate having an NCO functionality of at least 2, preferably from 2 to 6, in particular from 2.3 to 4.

If component B) is used, the ratio of component A) and A1) to component B) is preferably adjusted to 100:1 to 100: 6, preferably 100: 1 to 100: 4, based in each case on solids content.

Preferred polyisocyanates of component B) are polyether-modified or ionically modified biurets, allophanates, or trimers of hexamethylene diisocyanate (HDI) or of isophorone diisocyanate (IPDI). Nonionic polyisocyanates which are modified with the aid of polyethers are particularly preferred. For example, polyisocyanate mixtures which are obtainable by reaction of aliphatic or cycloaliphatic polyisocyanates with polyethylene oxide polyether alcohols having on statistical average less than 10 ethylene oxide units are suitable as such. They are disclosed, for example, in EP-A 540 985.

In addition to these purely nonionically hydrophilized, polyetherurethane-containing polyisocyanates, polyether-modified water-dispersible polyisocyanates which additionally have ionic groups, for example sulphonate groups (cf. for example EP-A 703 255) or amino or ammonium groups (cf. for example EP-A 582 166) for improving the emulsifiability or achieving special effects are also known.

In addition to the abovementioned polyisocyanates, polyisocyanates containing carbodiimide groups, such as, for example, BAYDERM® Fix CI (Bayer Chemicals AG), are also suitable as component B).

The following may be mentioned as examples of suitable polyisocyanates of component B):
reaction product of 80 parts of HDI trimer containing isocyanurate groups and 20 parts of an ethanol-initiated EO polyether having an average molecular weight of 350 g/mol;
reaction product of 90 parts of HDI trimer containing isocyanurate groups with 10 parts of a methanol-initiated EO polyether having an average molecular weight of 750 g/mol;
reaction product of 85 parts of HDI trimer containing isocyanurate groups with 15 parts of a butanol-initiated EO block copolyether having an EO/PO ratio of 7:3 and an average molecular mass of 2250 g/mol;
reaction product of 83 parts of HDI biuret and 17 parts of a methanol-initiated EO polyether having an average molecular mass of 650 g/mol;
reaction product of 87 parts of IPDI trimer with 13 parts of a 2:1 mixture of methanol-initiated EO polyethers having average molecular masses of 350 and 750 g/mol;
reaction product of 80 parts of HDI trimer containing isocyanurate groups with 3 parts of triethylene glycol and 17 parts of an ethanol-initiated EO polyether having an average molecular mass of 550 g/mol;
reaction product of 87 parts of HDI trimer containing isocyanurate groups with 0.2 part of N,N-dimethylethanolamine and 16.9 parts of a methanol-initiated EO polyether having an average molar mass of 350 g/mol, the tertiary amino group being protonated with dibutylphosphoric acid after the reaction;
reaction product of 85 parts of HDI trimer containing isocyanurate groups with 5 parts of the ethoxylated sodium salt of 1,4-butanediol-2-sulphonic acid [average molar mass 368 g/mol] and 10 parts of an ethanol-initiated EO polyether having an average molar mass of 370 g/mol.

The polyurethane systems according to the invention may contain further auxiliaries and additives, such as, for example, crosslinking agents having carbodiimide groups, for example BAYDERM® Fix CI, inorganic and organic pigments, dyes, levelling agents, ionic and nonionic viscosity regulators, natural and synthetic waxes, antifoams and hand agents.

The polyurethanes according to the invention or their aqueous polyurethane dispersions, preferably when used in the aqueous polyurethane system according to the invention, give, particularly on leather, coats which dry rapidly under the customary technical conditions of leather production. These coats advantageously serve as a wash primer for further coats (top coats) based on polymer dispersions, preferably polyurethane dispersions, in order to impart particularly high wet rub fastnesses and high wet, dry and low-temperature flexing endurances to the coated substrate.

The leathers coated with the polyurethanes or polyurethane dispersion according to the invention present no problems in particular during plating, embossing or stacking.

The use of the polyurethane dispersion according to the invention is advantageously effected by first preparing a corresponding ready-to-use finish liquor with which the leather substrate is coated. After drying of the coat, the leathers are embossed by means of an embossing plate which reproduces the negative image of the desired grain pattern, at from 80 to 120° C., at from 20 to 200 bar for from 1 to 10 seconds. In particular, continuous embossing machines which generate a contact pressure of from 100 to 200 bar at a temperature of 90 to 120° C. for an embossing time of from 1 to 3 seconds are preferred.

In spite of the low hardness of the bottoming coat, which is due to the use of the dispersion according to the invention, no adhesion to the plate is observed. The embossed pattern is very crisp and very exactly reproduces the fine relief structure of the embossing plate.

It is known that the adhesion of a coat to any desired substrate is generally adversely affected by adding silicones. Completely surprisingly, wet and dry adhesion of the bottoming coats are considerably improved by using the polyurethane dispersions according to the invention, although they contain silicones.

A further coat (top coat) which produces the final surface is then applied to the bottomed leather treated with the polyurethane dispersion according to the invention. After the drying of the coat, the leather is optionally plated and milled in order to impart a natural appearance to the leather.

The plating is effected as a rule with the aid of a plating press. The roll temperature is from about 80 to 120° C. and the roll pressure from 10 to 80 bar. The treatment takes from 1 to 10 seconds. Under this thermal pressure load, the grain pattern should not suffer any damage. This means that the edges of the embossed relief structure should not be blurred and the grain pattern should be retained as completely as possible. Completely surprisingly, it is found that the leathers produced using the polyurethane according to the invention have a substantially better embossing level than other polyurethane dispersions which have a similar Shore A hardness. The flexing endurances of the leathers obtained (dry flexing endurance, wet flexing endurance and low-temperature flexing endurance) and the wet rub fastness of the leathers meet all requirements or even surpass the requirements.

The dry and wet adhesion of the final leathers with a top coat is once again surprisingly substantially improved compared with those which were produced by means of a silicone-free polyurethane dispersion as bottoming.

After application to substrates, such as, for example, metal, wood, paper, textiles, plastic and in particular leather, and drying, the aqueous polyurethane systems give a cohesive film or homogeneous, defect-free coats which have correspondingly high wet rub fastnesses.

In spite of its incorporated silicone building block, the polyurethane system according to the invention surprisingly has extremely good levelling properties, which in turn leads to very clear finishes which do not impose a load on the leather. Consequently, very elegant finishes having a natural appearance are permitted. The optical transparency of the coats is not adversely affected by the incorporated silicone component. Surprisingly, high-gloss coats are therefore also possible, in contrast to conventional polyurethane dispersions which contain silicones only as additives, the silicones not being incorporated into the polyurethane, in spite of the low compatibility of the silicone component with the other polyurethane synthesis building blocks.

The polyurethane system according to the invention is also advantageous if it additionally contains conventional high molecular weight latices.

The polyurethane system according to the invention which has bottoming in crosslinking form in combination with a polyurethane top coat gives a finish having a clear surface. However, substrates, in particular leather, having a dull surface may also be demanded for fashion reasons. In order to meet these requirements, it is advantageous optionally to use organically coated silicas in the bottoming formulation itself, which contains the binder of component A). The silicas produce a dull surface of the finish and act as dulling agents. These silicas can particularly advantageously be used in the top coat. However, a proportionate addition to the bottoming is also possible. In the case of dull coats, too, no grey fracture occurs in the mechanical flexing of the coated substrate in the case of the polyurethane dispersions according to the invention. It is also possible to use organic dulling agents, for example optionally crosslinked polyurethane particles having a mean particle size of from 1 to 15 μm, which are obtainable according to DE-A4016713, or polyacrylate particles having a mean particle size of from 1 to 15 μm, which are obtainable, for example, according to DE-A-19911061.

The invention therefore furthermore relates to the use of the polyurethane according to the invention, preferably in the form of its aqueous polyurethane dispersion or of the aqueous polyurethane system according to the invention for the coating of a very wide range of substrates, preferably wood, paper, textile, plastic and metal, in particular of leather.

The present invention likewise relates to the substrates coated with polyurethane according to the invention, preferably in the form of its aqueous polymer dispersion, or with the aqueous polyurethane system according to the invention.

The invention furthermore relates to a process for the coating of substrates, in particular of leather, which is characterized in that the polyurethane according to the invention, preferably in the form of its aqueous polyurethane dispersion, or the aqueous polyurethane system according to the invention is applied to substrates.

Suitable application techniques are known methods, such as application with a doctor blade, spraying, casting or coating by means of a reverse roll coater. Spray finishing is preferred.

In the context of the invention, all other combinations of the general embodiments and preferred ranges disclosed above and the combination of the preferred ranges with one another are also considered to be disclosed preferred ranges.

### EXAMPLES

### Example 1

140.0 g of a linear hexanediol caprolactone carbonatediol having an average molar mass of 2000 g/mol, 209.5 g of a polytetrahydrofurandiol having a molar mass of 1000 and 11.1 g of dimethylolpropionic acid are initially taken in a 11 reactor having a stirrer and means for passing over N₂ and are dewatered for 30 min at 120° C. Cooling to 80° C. is then effected. 2.5 g of 2-ethylhexanol are added.

51.6 g of isophorone diisocyanate and 39.1 g of hexamethylene diisocyanate are then added at 80° C. while stirring. After the exothermic reaction has ceased, stirring is effected at 80° C. until the NCO content has fallen to 1.74%. Thereafter, 300 g of acetone are added, beginning at 80° C. and with simultaneous cooling, and stirring is effected at 60° C. until the NCO value is 1.04%.

The prepolymer is then transferred into a 21 reactor having a stirrer and means for passing over N₂, the prepolymer reactor is rinsed with 164.4 g of acetone and this wash liquid is likewise transferred into the 21 reactor. At 50-60° C., 3.1 g of α,ω-bis(3-aminopropyl)-polydimethylsiloxane having an average molar mass of 886 g/mol, a base N content of 3.16% and an amine functionality of 2.0 (content of permethylated cyclosiloxanes <0.5%) are added with rapid stirring, and stirring is effected for 60 minutes at 50° C. 7.5 g of triethylamine are then added. After stirring for a further 15 min, 800 g of water are introduced with vigorous stirring. A dispersion of the prepolymer forms.

Immediately thereafter, 2.5 g of ethylenediamine and 2.9 g of diethylenetriamine, dissolved in 24.6 g of water, are introduced with vigorous stirring. Vigorous stirring is continued for 20 min, after which the dispersion is stirred for a further 1 hour at moderate stirring power and 50° C.

The batch is then distilled at moderate stirring power under reduced pressure (about 100-250 mbar) and at a temperature of 40-60° C. The crude dispersion is cooled to room temperature and is adjusted to the desired solids content by addition of water.

A finely divided dispersion having the following characteristics results:

| | |
|---|---|
| Solids content (SC): | 35.2% |
| Mean particle size (LCS): | 85 nm |
| Efflux time (Ford cup/4 mm nozzle): | 29 seconds |
| Viscosity (20° C., 100 s⁻¹): | 27 mPa · s |

### Example 2

Example 1 is repeated, except that 6.3 g of α,ω-bis(3-aminopropyl)-polydimethylsiloxane (DMS-AL 1, ABCR; Gelest Inc.) having an average molar mass of 864 g/mol (N content: 3.24%, viscosity: 12 mpa.s) are used.

A finely divided dispersion having the following characteristics results:

| | |
|---|---|
| Solids content (SC): | 35.0% |
| Mean particle size (LCS): | 150 nm |
| Efflux time (Ford cup/4 mm nozzle): | 10 sec |

### Example 3

140.0 g of a linear hexanediol caprolactone carbonatediol having an average molar mass of 2000 g/mol, 209.5 g of a polytetrahydrofurandiol having a molar mass of 1000 and 11.1 g of dimethylolpropionic acid and 2.5 g (0.012 mol of OH) of an adduct of sodium bisulphite with propoxylated but-2-ene-1,4-diol are initially introduced into a 21 reactor having a stirrer and means for passing over N₂ and are dewatered for 30 min at 120° C. The mixture is then cooled to 80° C.

58.3 g of isophorone diisocyanate and 44.1 g of hexamethylene diisocyanate are then added at 80° C. while stirring. After the exothermic reaction has ceased, stirring is effected for 2 hours at 80° C. 300 g of acetone are then added dropwise in the course of 45 minutes, beginning at 80° C. and with simultaneous cooling, and stirring is effected for a further 2 hours at 60° C. until the NCO value is 1.57%. Thereafter, 150 g of acetone and 3.2 g of α,ω-bis(3-aminopropyl)polydimethylsiloxane having an average molar mass of 864 g/mol, an amine content of 3.24% and a viscosity (20° C.) of 12 mPa·s (DMS-A11; ABCR, Gelest Inc.) are added and stirring is effected for 45 minutes at 50° C. Thereafter, 7.5 g of triethylamine are added and stirring is effected for 15 minutes. 880 g of water are metered in rapidly with vigorous stirring. A homogeneous dispersion of the prepolymer immediately forms.

Immediately thereafter, 4.1 g of ethylenediamine and 4.6 g of diethylenetriamine, dissolved in 21.3 g of water, are introduced with vigorous stirring. Vigorous stirring is continued for 20 min, after which the dispersion is stirred for a further 2 hours at moderate stirring power and 50° C.

The batch is then distilled at moderate stirring power under reduced pressure (about 100-250 mbar) and at a temperature of 40-60° C. The crude dispersion is cooled to room temperature and is adjusted to the desired solids content by addition of water.

A finely divided dispersion having the following characteristics results:

| | |
|---|---|
| Solids content (SC): | 34.7% |
| Mean particle size (LCS): | 66 nm |
| Efflux time (Ford cup/4 mm nozzle): | 34.3 sec |

### Example 4

140.0 g of a linear hexanediol caprolactone carbonatediol having an average molar mass of 2000 g/mol, 209.5 g of a polytetrahydrofurandiol having a molar mass of 1000 and 11.1 g of dimethylolpropionic acid are initially taken in a 111 reactor having a stirrer and means for passing over. N₂ and are dewatered for 30 min at 120° C. Cooling to 80° C. is then effected. 2.5 g of 2-ethylhexanol are added.

51.6 g of isophorone diisocyanate and 39.1 g of hexamethylene diisocyanate are then added at 80° C. while stirring. After the exothermic reaction has ceased, stirring is effected at 80° C. until the NCO content has fallen to 1.74%. Thereafter, 750 g of acetone are added, beginning at 80° C. and with simultaneous cooling, and stirring is effected at 60° C. until the NCO value is 0.65%.

At 50° C., 3.1 g of α,ω-bis(3-aminopropyl)-polydimethylsiloxane having an average molar mass of 886 g/mol, a base N content of 3.16% and an amine functionality of 2.0 are added with rapid stirring, and stirring is effected for 45 minutes at 50° C. 7.5 g of triethylamine are then added.

After stirring for a further 15 min, the solution of prepolymer in acetone is introduced into 810 g of water at 40° C. with vigorous stirring. A dispersion of the prepolymer forms at a mixing temperature of 46.7° C.

Immediately thereafter, 2.5 g of ethylenediamine and 2.9 g of diethylenetriamine, dissolved in 24.6 g of water, are introduced with vigorous stirring and vigorous stirring is continued for 15 minutes. The dispersion is then stirred for a further 1 hour at moderate stirring power and 50° C.

The batch is then distilled at moderate stirring power under reduced pressure (about 100-500 mbar) and at a temperature of 40-60° C. The crude dispersion is cooled to room temperature and is adjusted to the desired solids content by addition of water.

A finely divided dispersion having the following characteristics results:

| | |
|---|---|
| Solids content (SC): | 35.4% |
| Mean particle size (LCS): | 135 nm |
| Efflux time (Ford cup/4 mm nozzle): | 17 seconds |
| Viscosity (20° C., 100 s⁻¹): | 12 mPa · s |

### Example 5

158.0 g of a linear hexanediol caprolactone carbonatediol having an average molar mass of 2000 g/mol, 200.5 g of a polytetrahydrofurandiol having a molar mass of 1000 and 11.1 g of dimethylolpropionic acid are initially taken in a 111 reactor having a stirrer and means for passing over N₂ and are dewatered for 30 min at 120° C. Cooling to 80° C. is then effected. 2.7 g of 2-ethylhexanol are added.

51.6 g of isophorone diisocyanate and 39.1 g of hexamethylene diisocyanate are then added at 80° C. while stirring. After the exothermic reaction has ceased, stirring is effected at 80° C. for 70 minutes. Thereafter, 750 g of acetone are added, beginning at 80° C. and with simultaneous cooling, and stirring is effected at 57-60° C. until the NCO value is 0.64%.

At 50° C., 3.1 g of α,ω-bis(3-aminopropyl)-polydimethylsiloxane having an average molar mass of 864 g/mol, a base N content of 3.24%, an amine functionality of about 2.0 and a viscosity of 12 mPa·s (20° C.) (DMS-A11, ABCR or Gelest Inc.), dissolved in 20 g of acetone, are added with rapid stirring, and stirring is effected for 40 minutes at 50° C. 7.5 g of triethylamine are then added.

After stirring for a further 15 min, the solution of prepolymer in acetone is introduced into 810 g of water at 40° C. with vigorous stirring. A dispersion of the prepolymer forms at a mixing temperature of 46° C.

Immediately thereafter, 2.6 g of ethylenediamine and 3.0 g of diethylenetriamine, dissolved in 24.6 g of water, are introduced with vigorous stirring and vigorous stirring is continued for 15 minutes. The dispersion is then stirred for a further 1 hour at moderate stirring power and 50° C.

The batch is then distilled at moderate stirring power under reduced pressure (about 100-200 mbar) and at a temperature of 40-60° C. The crude dispersion is cooled to room temperature and is adjusted to the desired solids content by addition of water.

A finely divided dispersion having the following characteristics results:

| | |
|---|---|
| Solids content (SC): | 34.5% |
| Mean particle size (LCS): | 85 nm |
| Efflux time (Ford cup/4 mm nozzle): | 32.5 seconds |

### Example 6

Example 1 was repeated, with the modification that an α,ω-bis(3-aminopropyl)-polydimethylsiloxane having an average molar mass of 886 g/mol, a base N content of 3.16% (total content of permethylated cyclosiloxanes of 7%) was used.

| | |
|---|---|
| Solids content (FC): | 35.6% |
| Mean particle size (LCS): | about 100 nm |
| Efflux time (Ford cup/4 mm nozzle): | 15.5 seconds |

### USE EXAMPLES

Unless stated otherwise, the stated amounts (parts) in the formulations for use are based on parts by weight.

Materials Used

1. Bottoming

The following were used as components for the bottoming formulation:
1.1 Colour: Formulation containing 26% of carbon black, 0.2% of a sheet silicate and 8.6% of a polyacrylic acid neutralized with ethanolanine.
1.2 Dulling agent: Formulation containing 19% of a silicate, 6% of varnish and 1.5% of an acrylate thickener which was neutralized with ammonia.
1.3 Detackifier emulsion containing 2% of wool fat, 8.5% of neatsfoot oil, 5% of casein, 1.6% of a fatty alcohol mixture, 1.5% of paraffin wax and 5% of a silicate dulling agent, which was rendered alkaline with ammonia.
1.4 Acrylate dispersion, 35% strength, having the following properties: 100% modulus: 0.3 MPa, tensile strength 4.0 MPa at 880% elongation.
1.5 Medium-hard 40% strength aliphatic polyurethane dispersion having the following properties: 100% modulus, 2.5 MPa, tensile strength: 20 MPa at 500% elongation.
1.6 Medium-hard 40% strength aliphatic-aromatic polyester/polyurethane dispersion having the following properties: 100% modulus, 4.7 MPa, tensile strength: 32.9 MPa at 600% elongation.
1.7 Polyurethane dispersions according to examples 1 to 6.
   2. Top coat

For the standard top coat formulation, the following components were used:
2.1 150 parts of a hard polyacrylate binder having the following film properties: 100% modulus: 3 MPa, tensile strength: 20 MPa at 300% elongation.
2.2 400 parts of a dulling agent formulation containing 5.0% of a silicate dulling agent, 44% of a solvent-free, soft polyurethane dispersion containing hydroxyl groups and 7% of a release wax, and neutralized with ethanolamine
2.3 20 parts of a silicone-containing hand agent
2.4 50 parts of water
2.5 20 parts of a silicone-containing levelling auxiliary
2.6 50 parts of a commercial solvent formulation of a crosslinking agent, consisting of a polyether-modified polyisocyanate mixture based on an HDI trimer having an NCO content of 12.5% and an NCO functionality of 2.7.
   3. Leather finishing

For all experiments on leather, an unfinished automotive crust leather was used. A bottoming was applied to this substrate as follows:

For the bottoming, a mixture of colour (1.1), a dulling agent (1.2), a softening detackifier (1.3), one or more commercial soft binders based on polyacrylate (1.4), based on a polyurethane dispersion (1.5), and a polyurethane dispersion (1.6) or a polyurethane dispersion (1.7) according to the invention and water is prepared. This mixture is sprayed twice (one cross each) onto the prebottomed leather. Drying is effected for 5 min at 70° C. The leather is hydraulically embossed.

The respective embossing conditions are shown in the following table of the use examples.

A part of the bottomed leather is used for the production of test specimens for assessing the adhesion properties and the embossing behaviour. The bottomed and embossed leather is finished with a standard top coat (2.). For this purpose, the top coat mixture (one cross) is sprayed onto the bottomed leather. Intermediate drying was effected for 5 min at 80° C. in a circulation drying oven.

A further cross of the standard top coat (2.) was then sprayed until moisture was visible. Drying is effected again for 5 min at 80° C. Plating was then effected on the continuous plating machine at 100° C. roll temperature, 50 bar pressure and 6 m per minute.

The physical leather fastnesses were determined according to DIN 53 351 (flexing endurances) or DIN 53 399 (rub fastnesses). In addition, adhesion values (dry and wet adhesion), the hydrolysis stability, the processing behaviour during embossing (tendency to stick to the embossing plate) and the optical embossed pattern and the embossing level after plating of the top coat are evaluated.

Legend for Assessment of the Leathers according to Tables 1 and 2

The degree of damage to the finish in the case of the stated number of dry flexes, wet flexes, low-temperature flexes.

| | |
|---|---|
| o: | No damage |
| o-x: | Visible change |
| x: | Slight damage |
| x-xx: | Substantial change |
| xx: | Very great damage |

Wet rubs: Number of wet rubs/degree of discoloration of the felt (5=no discoloration, very good fastness; 1=strong discoloration, very poor rub fastness)/degree of damage to the finish.
Embossed pattern: The visual impression was described in ratings from 1 to 8:
1=Very natural embossed pattern, round milled grain, no cutting through the relief structure in the valleys, very good embossing level after spraying of the top coat and final plating of the finish.
8=Insufficient embossed pattern, e.g. cutting through the embossing, sharp edge, embossing too strongly structured, irregular and also too flat etc., excessive levelling of the embossed pattern after application of the top coat and after plating of the finish.
   Hydrolysis Test:

The stability of the mechanical properties of the finish film on a leather sample after storage at 70° C. and 98% relative humidity (14 days) is assessed. Tensile strength and elongation at break are assessed by the test in comparison with the comparative sample without ageing. Stable=no deterioration of the properties.

Adhesion:

The adhesion is tested by measuring the force, in Newton, which is required to tear off an adhesive strip from a finished leather sample. In addition, the leather samples are investigated with regard to damage. An assessment is also carried out to determine where the failure of the finish occurs.

The tables below show the details of the bottoming formulations, containing the polyurethane dispersions according to the invention, and the processing conditions.

TABLE 1

| Component | Use example 1 | Use example 2 | Use example 3 | Use example 4 | Use example 5 |
|---|---|---|---|---|---|
| Colour 1.1 | 100 | 60 | 60 | 60 | 60 |
| Dulling agent 1.2 | — | 60 | 60 | 60 | — |
| Detackifier 1.3 | 200 | 160 | 160 | 160 | 200 |
| Acrylate binder 1.4 | — | 200 | 200 | 200 | — |
| PU binder 1.5 | — | — | — | — | 150 |
| Soft PU disp. 1.6 | — | 50 | 50 | 50 | — |
| Dispersion from | 494 | 203 | 200 | 200 | 350 |
| examples 1 to 6 | (Ex. 4) | (Ex. 4) | (Ex. 6) | (Ex. 1) | (Ex. 1) |
| (adhesive binder) | | | | | |
| Water | 206 | 200 | 200 | 200 | 240 |
| Embossing conditions | 110° C., | 80° C., | 90° C., | 100° C., | 100° C., |
| | 220 bar, | 150 bar, | 220 bar, | 220 bar, | 220 bar, |
| | 3 s | 2 s | 2 s | 3 s | 3 s |
| Embossed pattern | 5 | 2 | 1 | 3 | 2 |
| Adhesion to embossing plate | No | No | No | No | No |
| Adhesion dry bottom [N] | 10/11 | n.d. | n.d. | n.d. | n.d. |
| Adhesion wet bottom [N] | >5.2/6 | n.d. | n.d. | n.d. | n.d. |
| Adhesion dry top [N] | >5/>5.2 | >3.4/>4.5 | >4/>5 | 6.8/7.5 | 5.3/8 |
| Adhesion wet top [N] | 7/7.4 | 3.5/3 | >2.5/>2.5 | 3.4/4.2 | 5/5 |
| Observations on spraying | very good | very good | very good | very good | very good |
| | levelling | levelling | levelling | levelling | levelling |
| Flexes dry | 100000 o | 100000 o | 100000 o | 100000 o | 100000 o |
| Flexes wet | 20000 o | 20000 o | 20000 o | 20000 o | 20000 o |
| Hydrolysis test | Stable | Stable | Stable | Stable | Stable |
| Wet rubbing | 1000 5 o | 1000 5 x | 1000 5 o | 1000 5 o | 1000 5 o |
| Shore A hardness | 51 | 51 | 37 | 45 | 45 |
| (adhesive binder film) | | | | | |
| Elongation: maximum/ | 900/120 | 900/120 | >1100/138 | 1075/130 | 1025/138 |
| after 60 s_relaxation | | | | | |
| [%] (adhesive binder | | | | | |
| film) | | | | | |

TABLE 2

| Component | Use example 6 | Use example 7 |
|---|---|---|
| Colour 1.1 | 100 | 100 |
| | (DB) | (DB) |
| Dulling agent 1.2 | — | — |
| Detackifier 1.3 | 200 | 200 |
| Acrylate binder 1.4 | — | — |
| PU binder 1.5 | 150 | 150 |
| Soft PU disp. 1.6 | — | — |
| Dispersion from | 337 | 355 |
| examples 1 to 6 | (Ex. 3) | (Ex. 5) |
| (adhesive binder) | | |
| Water | 213 | 195 |
| Embossing | 100° C./220 bar/2 s | 100° C./220 bar/2 s |
| conditions | | |
| Embossed pattern | 2 | 5 |
| Adhesion to | No | No |
| embossing plate | | |
| Adhesion dry bottom [N] | 8.3 | 9.5/10 |
| Adhesion wet bottom [N] | 4.5/5 | 4.5/4 |
| Adhesion dry top [N] | 8.3/7.6 | 4/8 |
| Adhesion wet top [N] | 3.2/4.0 | 6.5/7 |
| Observation on | Good levelling | Very good |
| spraying | | levelling |
| Flexes dry | 100000 o | 100000 o |
| Flexes wet | 20000 o | 20000 o |
| Hydrolysis test | Stable | Stable |
| Wet rubbing | 1000 5 o | 1000 5 x |
| Shore A hardness | 40 | 36 |
| (adhesive binder film) | | |
| Elongation: | >1100/170 | 1025/150 |
| maximum/after 60 s | | |
| relaxation [%] | | |
| (adhesive binder film) | | |

It is evident from the tables that as a rule leathers having the following fastnesses result:
Wet rubs: >1000 without damage; dry and wet flexes: 10⁶ and 2×10⁵, respectively, without problems; low-temperature flexes (−20° C.): 30 000 without damage.

1. Polyurethane which is obtainable by reacting
a) an NCO-containing prepolymer composed of
a1) at least one polyesterpolyol, preferably polycarbonatepolyol, carbonate group-free polyesterpolyol, polyestercarbonatepolyol, polyesteramidepolyol, in particular polyesterdiol, having an average molecular weight, determined as the number average, greater than or equal to 500 g/mol, preferably from 500 to 6000 g/mol, in particular from 500 to 4000 g/mol, very particularly preferably from 800 to 4000 g/mol, and
a2) at least one polyetherpolyol which differs from a1) and is free of ester groups, preferably polyalkylene glycol, such as polyethylene glycol, polypropylene glycol, polytetramethylene glycol, polyhexamethylene glycol and copolyethers, in particular those containing building blocks from the group consisting of ethyleneoxy, propyleneoxy, tetramethyleneoxy and/or hexamethyleneoxy, having a molecular weight, determined as the number average, greater than or equal to 500, preferably from 500 to 10 000 g/mol, in particular from 500 to 4000, particularly preferably from 800 to 4000, g/mol, preferably a polyetherdiol, and
a3) at least one polyol, in particular diol, having a molecular weight of less than 500 g/mol, which carries one or more ionic groups and/or one or more potentially ionic groups, preferably carries one or more carboxylate groups, and
a4) at least one aliphatic polyisocyanate, preferably diisocyanate, preferably having a molecular weight of less than 500 g/mol, in particular from 112 to 400 g/mol, particularly preferably from 168 to 262 g/mol, and
a5) optionally a nonionic polyol, preferably diol having a molecular weight of less than 500 g/mol, preferably from 61 to 499 g/mol, and
a6) optionally a monoalcohol
with
b) at least one polysiloxane reactive towards NCO groups and having a molecular weight, determined as the number average, of less than 1500 g/mol, preferably having 1 to 6, in particular 1 to 3, amino and/or hydroxyl groups reactive towards NCO groups, in particular amino groups, and
c) at least one amine reactive towards NCO groups and having an average amino functionality of from 1 to 6 and a molecular weight of less than 500 g/mol (molecular weight determined as the number average), which may be substituted by hydroxyl groups and/or sulpho groups and/or carboxyl groups, and
d) water,
the molar ratio of the hydroxy-functional compounds used for the preparation of the prepolymer a) to the polyisocyanate being from 1:11 to 1: 2.5, preferably from 1.1: 1 to 1:1.7.

2. Polyurethane according to claim 1, characterized in that the mean particle size of the polyurethane is less than 200 nm, preferably from 20 to 150 nm, in particular from 40 to 100 nm.

3. Polyurethane according to at least one of claims 1 and 2, characterized in that the polyurethane has a silicone content of from 0.0001 to 10%, preferably from 0.001 to 2.5%, particularly preferably from 0.001 to 1%, based in each case on solids content.

4. Polyurethane according to at least one of claims 1 to 3, characterized in that the polysiloxane is completely incorporated into the polyurethane.

5. Aqueous dispersions containing at least one polyurethane according to at least one of claims 1 to 4.

6. Process for the preparation of the polyurethane according to at least one of claims 1 to 4, characterized in that the components a1) to a4) and optionally a5) and/or a6) are reacted to give an NCO prepolymer, this is then reacted with the silicone component b), the optionally present potentially ionic groups, in particular carboxylic acid groups, are then neutralized with a base which is not reactive towards NCO groups, and this neutralized prepolymer is reacted with the component c) and water to give a polyurethane.

7. Polyurethane system containing the component A) and at least one of the components A1) and B)
A) at least one polyurethane according to at least one of claims 1 to 4 or a polyurethane dispersion according to claim 5,
A1) optionally one or more further polymer dispersions, such as polyacrylate dispersions or polyurethane dispersions, and
B) optionally a water-dispersible, aliphatic or cycloaliphatic polyisocyanate having an NCO functionality of at least 2, preferably from 2 to 6, in particular from 2.3 to 4.

8. Use of the polyurethane according to at least one of claims 1 to 4, of the aqueous polyurethane dispersion according to claim 5 or of the polyurethane system according to claim 7 for the coating of various substrates, in particular wood, metal, textile, paper, plastic and leather.

9. Substrates coated with the polyurethane according to at least one of claims 1 to 4, with the aqueous polyurethane dispersion according to claim 5 or with the polyurethane system according to claim 7, in particular wood, metal, textile, paper, plastic and leather.

10. Process for the coating of substrates, characterized in that polyurethanes according to any of the claims or the polyurethane system according to claim 7 are or is applied to substrates.

11. Substrates coated with at least one polyurethane according to any of claims 1 to 4, aqueous polyurethane dispersions according to claim 5 or the polyurethane system according to claim 7.
